(19) United States
(12) Patent Application Publication
(10) Pub. No.: US 2019/0199704 A1
(43) Pub. Date: Jun. 27, 2019

(54) SYSTEM AND METHOD FOR NON-NUMERIC AUTHENTICATION USING A LEGACY TELEPHONE

(71) Applicant: Avaya Inc., Santa Clara, CA (US)

(72) Inventors: Milos Pujic, Belleville (CA); Joel Ezell, Broomfield, CO (US); Rifaat Shekh-Yusef, Belleville (CA)

(21) Appl. No.: 15/854,555

(22) Filed: Dec. 26, 2017

(51) Int. Cl. H04L 29/06

(52) U.S. Cl. CPC H04L 63/083; H04M 3/382; H04L 63/0861; H04L 63/0815

(57) ABSTRACT

A request to authenticate a user is received at an authentication system. The request to authenticate the user requires one or more non-numeric metrics to authenticate the user. For example, the one or more non-numeric metrics may include a user name, a password, and a fingerprint scan. The request to authenticate the user that requires the one or more non-numeric metrics is validated. In response to validating the request to authenticate the user that requires the one or more non-numeric metrics, a first numeric code is generated (e.g., a password). The first numeric code is used to grant access to a telephone that requires authentication via a numeric keypad. The first numeric code is sent and displayed to the user. The user can then access the telephone by providing the numeric code at the telephone.

### BACKGROUND

Businesses are becoming increasingly security conscious and are demanding stronger authentication methods with all their enterprise applications. Telecommunication applications are no exception. The days of short, numeric-only passwords for communication/telephony applications are coming to an end. Businesses are increasing the use of single sign-on technologies and multi-factor authentication (MFA), such as, using biometrics in the single sign-on process. Businesses would like to apply these types of technologies to existing legacy telephony systems as well. However, they have invested millions of dollars in the legacy telephone systems that only support numeric keypads and have no ability to interface to enterprise Identity Providers (IdP).

### SUMMARY

These and other needs are addressed by the various embodiments and configurations of the present disclosure. A request to authenticate a user is received at an authentication system. The request to authenticate the user requires one or more non-numeric metrics to authenticate the user. For example, the one or more non-numeric metrics may include a user name, a password, and a fingerprint scan. The request to authenticate the user that requires the one or more non-numeric metrics is validated. In response to validating the request to authenticate the user that requires the one or more non-numeric metrics, a first numeric code is generated (e.g., a password). The first numeric code is used to grant access to a telephone that requires authentication via a numeric keypad. The first numeric code is sent and displayed to the user. The user can then access the telephone by providing the numeric code at the telephone.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for providing non-numeric authentication using a telephone with a numeric keypad.

FIG. 2 is a flow diagram of a process for providing non-numeric authentication using a telephone with a numeric keypad.

FIG. 3 is a flow diagram of a process for verifying a numeric password in a telephone.

FIG. 4 is a flow diagram of a process for granting access to a telephone when a numeric password has not expired.

FIG. 5 is a flow diagram of a process for providing authentication using a single sign-on password for multiple legacy systems.

### DETAILED DESCRIPTION

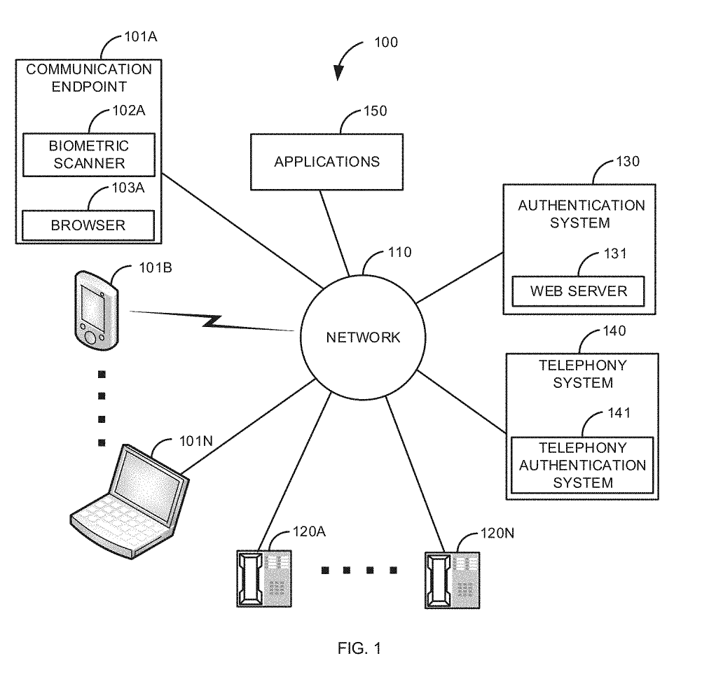

FIG. 1 is a block diagram of a first illustrative system for providing non-numeric authentication using a telephone 120 with a numeric keypad. The first illustrative system 100 comprises communication endpoints 101A-101N, a network 110, telephones 120A-120N, an authentication system 130, a telephony system 140, and applications 150.

The communication endpoints 101A-101N can be or may include any communication endpoint device that can communicate on the network 110 to provide communication services, such as a Personal Computer (PC), a telephone 120, a video system, a cellular telephone 120, a Personal Digital Assistant (PDA), a tablet device, a notebook device, a smartphone, a security access point, a security terminal, an authentication device, and/or the like. The communication endpoints 101A-101N are devices where a communication session ends. The communication endpoints 101A-101N are not network elements that facilitate and/or relay a communication session in the network 110, such as a communication manager or router. As shown in FIG. 1, any number of communication endpoints 101A-101N may be connected to the network 110.

The communication endpoint 101A further comprises a biometric scanner 102A and a browser 103A. Although not shown, the communication endpoints 101B-101N may also comprise the biometric scanner 102 and the browser 103. Although not shown, the communication endpoints 101A-101N may comprise other elements for providing authentication, such as a card reader, a camera, a user interface, a signature entry element, and/or the like.

In one embodiment, the communication endpoint 101 may not have the biometric scanner 102. In this embodiment, the user, via the browser 103, establishes a secure communication session with the authentication system 130, via the web server 131, to authenticate with the authentication system 130.

The biometric scanner 102A can be or may comprise one or more types of biometric scanners 102, such as a camera (for facial recognition), a finger print scanner, a rental scanner, a hand scanner, a voice analyzer, and/or the like.

The browser 103A can be or may include any browser, such as Google Chrome™, Internet Explorer™, Safari™, Firefox™, Opera™, and/or the like. The browser 103A is used to interface with the web server 131 (i.e. in conjunction with the biometric scanner 102A) to allow a user to access the authentication system 130.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, an enterprise network, a combination of these, and the like. The network 110 can use a variety of electronic protocols, such as Ethernet, Internet Protocol (IP), Session Initiation Protocol (SIP), Integrated Services Digital Network (ISDN), web protocols, and/or the like. Thus, the network 110 is an electronic communication network configured to carry messages via packets and/or circuit switched communications.

The telephones 120A-120N can be or may include any telephone 120 that provides limited authentication capability. For example, telephone 120A-120N may only be capable of authentication via a numeric keypad. The telephones 120A-120N may have limited authentication capabilities in that they have limited display/input capability, are incapable of biometric authentication, do not support non-numeric passwords, are not capable of new software downloads, do not currently support authentication, and/or the like.

The authentication system 130 can be or may include any hardware coupled with software that allows a user to access an application 150. The authentication process of the authentication system 130 may comprise one or more non-numeric authentication metrics, such as a password, an identification card (e.g. a security card), a digital certificate, a finger print scan, a hand scan, a person's signature, a retinal scan, facial recognition, voice recognition, security questions, and/or the like. In one embodiment, the authentication system 130 may be a single sign-on system that can grant access to multiple applications 150 at a single time.

The authentication system 130 further comprises a web server 131. The web server 131 can be or may include any web server 131 that can provide authentication services for the authentication system 130. For example, the web server 131 may provide a single sign-on, via the communication endpoint 101A using the browser 103A.

Although not shown, an authentication process between a communication endpoint 101 and the authentication system 130 may work without the browser 103/web server 131. For example, an authentication application may be loaded onto the communication endpoint 101 that allows a user to authenticate using the authentication system 130.

The telephony system 140 can be or may include any hardware coupled with software that can manage the telephones 120A-120N, such as, a Private Branch Exchange (PBX), a central office switch, a session manager, a communication manager, a proxy server, and/or the like. The telephony system 140 may be a legacy telephone system 140 (e.g., a legacy telephony system 140 with updates to the telephony authentication system 141). The telephony system 140 further comprises a telephony authentication system 141. The telephony authentication system 141 can be or may include any hardware coupled with software that provides authentication services for the telephone 120A-120N.

The applications 150 can be or may include any types of applications 150, such a database services, a telephony service, a voicemail system, an email system, a chat service, a facility access service, a mobile device application (e.g., installed on a communication endpoint 101), a web server 131, a computer application, a word processing application, a document retrieval service, a customer database, a directory service, a computer access service, a Back-to-Back User Agent (B2BUA, e.g., a Session Initiation Protocol (SIP) B2BUA), and/or the like. The applications 150 may comprise multiple applications 150 on multiple devices in the network 110, such as, on servers, on communication systems, on the authentication system 130, on the telephony system 140, and/or on the communication endpoints 101A-101N.

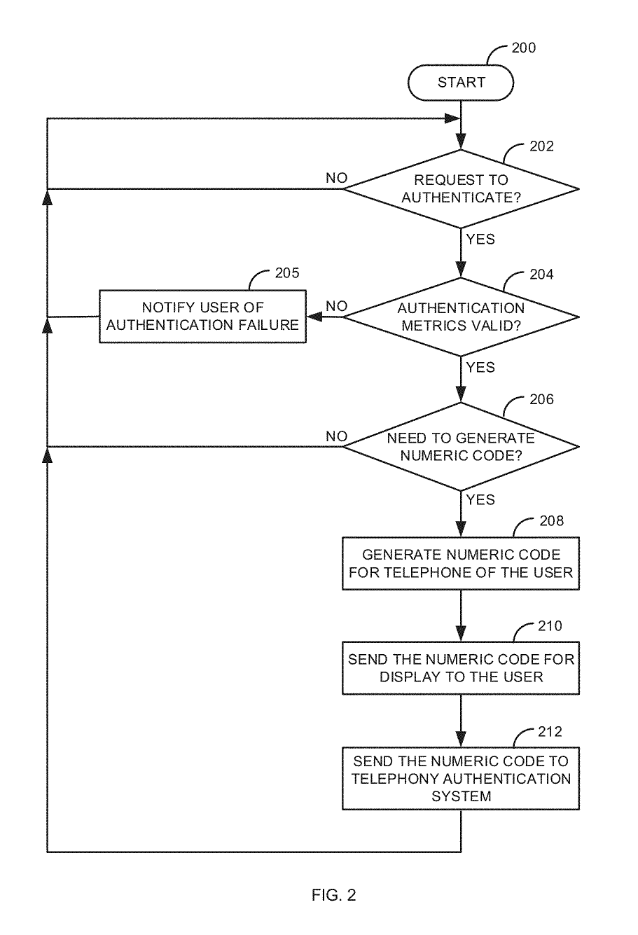

FIG. 2 is a flow diagram of a process for providing non-numeric authentication using a telephone 120 with a numeric keypad. In FIG. 2, the communication endpoints 101A-101N, the biometric scanner 102A, the browser 103A, the telephones 120A-120N, the authentication system 130, the web server 131, the telephony system 140, the telephony authentication system 141, and the applications 150 are stored-program-controlled entities, such as a computer or microprocessor, which performs the method of FIGS. 2-5 and the processes described herein by executing program instructions stored in a computer readable storage medium, such as a memory (i.e., a computer memory, a hard disk, and/or the like). Although the methods described in FIGS. 2-5 are shown in a specific order, one of skill in the art would recognize that the steps in FIGS. 2-5 may be implemented in different orders and/or be implemented in a multi-threaded environment. Moreover, various steps may be omitted or added based on implementation.

The process starts in step 200. The authentication system 130 determines if a user has made a request to authenticate in step 202. A request to authenticate is where a user provides one or more non-numeric authentication metrics, such as a user name, a password, a biometric scan, a security card, and/or the like. In addition to the one or more non-numeric authentication metrics, the user may also provide one or more numeric authentication metrics. For example, a password may contain numeric characters along with non-numeric characters.

A user may request to authenticate in numerous ways. For example, a user at the communication endpoint 101A may access the authentication system 130/web server 131 via the browser 103A by providing a user name, a password, and a digital certificate. Alternatively, the request to authenticate may come via an authentication access point (a communication endpoint 101 that has an authentication application) that may include a display, a voice analyzer, and a biometric scanner 102. If a request to authenticate has not been received in step 202, the process repeats step 202 until a request to authenticate is received.

Otherwise, if a request to authenticate has been received in step 202, the authentication system 130 determines if the authentication metrics are valid in step 204. For example, if a user has provided a user name, a password, and a fingerprint scan, the authentication system 130 validates if the password and fingerprint scan match the user associated with the user name. If the all the authentication metrics are not valid in step 204, the authentication system 130 notifies the user that the authentication failed in step 205. The process then goes back to step 202.

If the one or more authentication metrics are valid in step 204, the authentication system 130 determines, in step 206, if there is a need to generate a numeric code (e.g., a numeric password). The numeric code of step 206 is a numeric code that the user enters at the telephone 120 to gain access to the telephony system 140 (e.g., to make a voice call). The numeric code is typically a longer numeric code (e.g., 10-20 characters) that has an associated time period for when the numeric code is valid. For example, the numeric code may be valid for two weeks after the numeric code is generated or entered. The user will then be able to use the telephone 120 for the time period without entering a numeric code. The time period for the numeric code may be administered by an administrator or supervisor.

Alternatively, the numeric code may be a one-time use numeric code. In this embodiment, the user has to get a new numeric code each time the telephone 120 is used. In one embodiment, the numeric code may have to be entered each time the phone is accessed. In this embodiment, the numeric code may be associated with a time period. The user can enter the same numeric code each time the telephone 120 is accessed until the numeric code expires.

In one embodiment, the user may select a button or other graphical user interface element to generate the numeric code after the authentication metrics have been validated in step 204. This way the user can generate a new numeric code any time if necessary.

If there is not a need to generate a numeric code in step 206, the process goes back to step 202. Otherwise, if there is a need to generate a numeric code in step 206, the authentication system 130 generates the numeric code for the telephone 120 of the user in step 208. The authentication system 130 may generate the numeric code in various ways, such as, using a random number generator, using attributes associated with a user, and/or the like. The authentication system 130 sends, in step 210, the numeric code (e.g., using an encrypted communication session) for display to the user. For example, the user may have accessed the authentication system 130 from the communication endpoint 101A via the web server 131. The web server 131 sends the numeric code to the user, which is displayed in the browser 103A.

The authentication system 130 sends, in step 212, the generated numeric code to the telephony authentication system 141 (e.g., using an encrypted communication session). The sent numeric code of step 212 may also comprise additional information associated with the numeric code, such as, a user name, a specific telephone 120 associated with the user, an expiration date of the numeric code, whether the numeric code is a one-time use code, whether the user has to enter the code each time during the time period, and/or the like. The process then goes back to step 202.

The telephony authentication system 141 uses the generated numeric code as part of an authentication process to allow the user to access the telephone 120 (e.g., to make secure a voice or video call). This way, access to the telephone 120 is based on enhanced non-numeric authentication metrics, such as, biometric authentication. Biometrics and other types of non-numeric authentication metrics could not be used previously because the previous passwords for the telephones 120A-120N were not generated based on non-numeric metrics. For example, the user may have just chosen a short numeric password (e.g., 4 characters). With the numeric code being longer (e.g., 10-20 characters) and being generated based on non-numeric authentication metrics, access to the telephone 120 has become more secure.

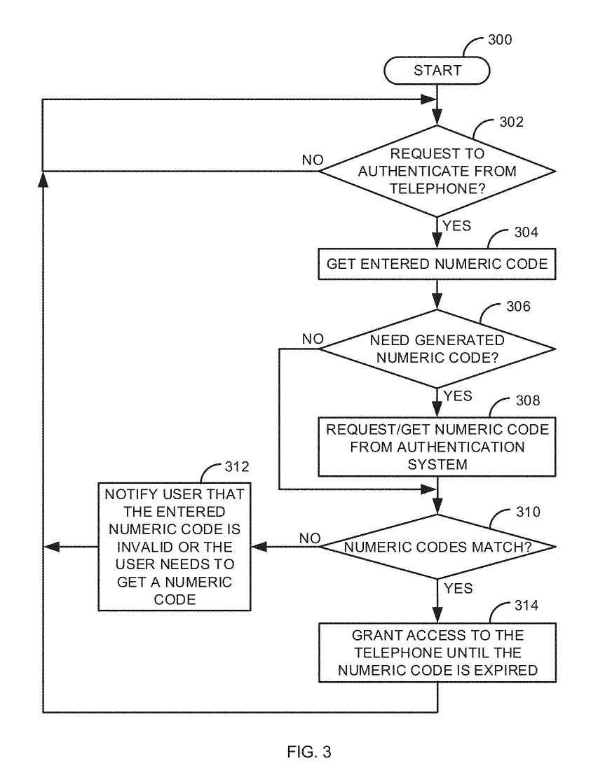

FIG. 3 is a flow diagram of a process for verifying a numeric password (a numeric code) in a telephone 120. The process of FIG. 3 allows users at the telephones 120A-120N to login to the telephone system 140 using the same login process (by entering numeric codes using a keypad) that was used before the authentication system 130 was added. The authentication system 130 can communicate with the telephony authentication system 141 to provide enhanced non-numeric authentication services for the installed base of legacy telephones 120A-120N while still keeping the existing authentication processes of the legacy telephones 120A-120N. The process starts in step 300. The telephony authentication system 141 determines, in step 302, if a request to authenticate is received from the telephone 120. For example, the user enters the numeric code (that was displayed to the user in step 210) based on a pop-up window displayed to the user on the telephone 120 when the user tries to access the telephone 120. The user may enter the numeric code in various ways, such as, by selecting a menu on the telephone 120 and then entering the numeric code via the numeric keypad on the telephone 120. Alternatively, the user may enter the numeric code when first attempting to make a voice call using the telephone 120. In this example, the user may be asked to provide the numeric code via the numeric keypad when making the voice call.

If a request to authenticate from the telephone 120 is not received in step 302, the process of step 302 repeats. Otherwise, if a request to authenticate is received from the telephone 120 in step 302, the telephony authentication application 141 gets, in step 304, the numeric code entered by the user at the telephone 120. In one embodiment, the request to authenticate may where a digest (e.g., a Session Initiation Protocol (SIP) digest) is used. In this case, the numeric code is not actually sent across the wire by the communication endpoint 101. Instead, the communication endpoint 101 creates a hashed value of the numeric code. The hashed value is compared to a hash value generated by the telephony authentication system 141 using the numeric code in step 310. The telephony authentication system 141 determines, in step 306, if it needs to get the generated a numeric code (generated in step 208). In one embodiment, instead of the authentication system 130 sending the numeric code to the telephony authentication system 141 in step 212 when the numeric code is generated, the telephony authentication system 141 may request the numeric code when the user attempts to authenticate from the telephone 120 in step 308. For example, the telephony authentication system 141 may request the latest numeric code (if one is still valid) for the user each time the user tries to authenticate at the telephone 120. If a numeric code is not needed in step 306, the process goes to step 310.

If there is a need for the numeric code in step 306, the telephony authentication system 141 requests and gets the numeric code from the authentication system 130 in step 308. Although not shown, if the numeric code cannot be retrieved in step 308 (e.g., the network 110 is down), an error message may be given to the user and the process goes to step 302. If a numeric code has not been previously generated for the user or the numeric code is no longer valid, a null numeric code or an indicator that a numeric code has not been generated/is invalid is returned in step 308.

The telephony authentication system 141 determines if the generated numeric code matches the numeric code entered by the user in step 310. This check also includes where a numeric code has not yet been generated/or is invalid. If the generated numeric code does not match entered numeric code or a numeric code has not been by generated for the user/is invalid, in step 310, the telephony authentication system 141 (i.e., via the telephone 120) notifies, in step 312, that the user has entered an invalid numeric code instep 312 or that the user needs to get a numeric code and the process goes back to step 302.

Otherwise, if the generated numeric code matches the numeric code input by the user in step 310, the telephony authentication system 141 grants access to the telephone 120 until the numeric code is expired in step 314. The process then goes to step 302.

The process of step 310 may also check for other attributes associated with the numeric code. For example, the telephony authentication system 141 may check the information associated with the generated numeric code such as a telephone number. If the telephone number of the telephone 120 does not match the telephone associated with the numeric code, the user may be denied access to the telephone 120. Other factors may be taken into consideration, for example, whether the numeric code is a one-time use code, whether the user has to enter the code each time during the time period may also be taken into consideration when implementing FIG. 3.

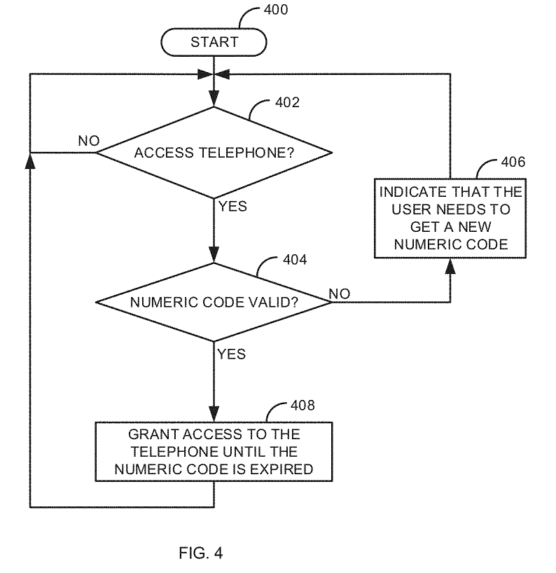

FIG. 4 is a flow diagram of a process for granting access to a telephone 120 when a numeric password (a numeric code) has not expired. The process of FIG. 4 is executed after the user initially enters the numeric code as described in FIG. 3. The process of FIG. 4 is where the numeric code has a time period for when the numeric code is valid.

The process starts in step 400. The telephony authentication system 141 determines, in step 402, if a user is trying to access the telephone 120. For example, the user is trying to make a voice call from the telephone 120. If the user is not accessing the telephone 120 in step 402, the process of step 402 repeats. If the user is accessing the telephone 120 (and the user has previously provided a numeric code) the telephony authentication system 141 determines, in step 404, if the numeric code (from step 304) is still valid. If the numeric code is no longer valid in step 404, the telephony authentication system 141, via the telephone 120, indicates that the user needs to get a new numeric code in step 406. The process then goes back to step 402. Otherwise, if the numeric code has not expired in step 404, the telephony authentication system 141 grants access, in step 408, to the telephone 120 until the numeric code expires. The process then goes back to step 402.

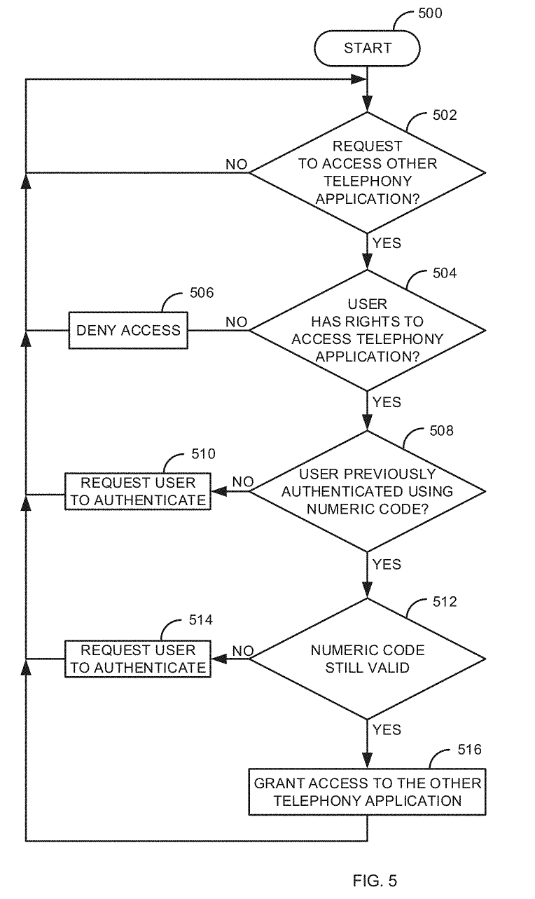

FIG. 5 is a flow diagram of a process for providing sign-on using a single sign-on password for multiple legacy systems. The process starts in step 500. The telephony authentication system 141 determines, in step 502, if the user has requested to access another telephony application. The other telephony application is controlled by the telephony authentication system 141. For example, the other telephony application may be a voicemail system. If the user has not requested to access other telephony application in step 502, the process repeats step 502.

Otherwise, if the user has requested to access another telephony application in step 502, the telephony authentication system 141 determines, in step 504, if the user has rights to access the other telephony application. If the user does not have rights to access the other telephony application in step 504, the telephony authentication system 141 denies access to the other telephony application in step 506. The process then goes back to step 502.

If the user has rights to access the other telephony application in step 404, the telephony authentication system 141 determines if the user has previously authenticated using the numeric code (e.g., as described in FIG. 3) in step 508. If the user has not previously authenticated using the numeric code in step 508, the user is requested to authenticate in step 510. The process then goes to step 502.

If the user has previously authenticated using the numeric code in step 508, the telephony authentication system 141 determines, in step 512, if the numeric code is still valid. If the numeric code is no longer valid in step 512, the user is requested to authenticate (e.g., as described in FIGS. 2-3) in step 514. The process then goes to step 502.

If the numeric code is still valid in step 512, the telephony authentication system 141 grants access to the other telephony application in step 516. The process then goes back to step 502.

The access granted to the telephony application in step 516 may happen in various ways. For example, the authentication system 130 may be a token based/assertion single sign-on mechanism, such as OAuth. The telephone authentication system 141 may acquire, from the authentication system 130 (e.g., in step 212), based on the valid numeric code, an authentication token and may attach the authentication token to a service request to access the other telephony application. The other telephony application then uses the token to decide whether to provide service/access or not.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones 120 (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for authenticating a user comprising:
a microprocessor; and
a computer readable medium, coupled with the microprocessor and comprising microprocessor readable and executable instructions that program the microprocessor to execute:
an authentication system that receives a request to authenticate the user, wherein the request to authenticate the user requires one or more non-numeric metrics to authenticate the user; validates the request to authenticate the user that requires the one or more non-numeric metrics; generates a first numeric code in response to validating the request to authenticate the user that requires the one or more non-numeric metrics, wherein the first numeric code is used to grant access to a telephone that requires authentication via a numeric keypad; and sends the first numeric code for display to the user.

2. The system of claim 1, wherein the authentication system sends the first numeric code to a telephony authentication system of the telephone, wherein the telephony authentication system authenticates the user at the telephone by comparing the first numeric code to a second numeric code input at the telephone.

3. The system of claim 2, wherein the sent first numeric code is sent based on a request from the telephony authentication system.

4. The system of claim 2, wherein the sent first numeric code is sent based on generating the first numeric code.

5. The system of claim 2, wherein the sent first numeric code is associated with a validity time period.

6. The system of claim 2, wherein telephony authentication system grants access to the telephone if the first numeric code matches the second numeric code.

7. The system of claim 6, wherein the telephony authentication system grants access to an other telephone system based on the access granted to the telephone as part of a single sign-on process.

8. The system of claim 2, wherein comparing the first numeric code to the second numeric code input at the telephone comprises comparing a hash of the first numeric code to a hash of the second numeric code.

9. The system of claim 1, wherein the one or more non-numeric metrics comprise at least one of: a user name, a password, a voiceprint, a facial recognition, a fingerprint, a palm print, a digital certificate, a security card, a user signature, and an iris scan.

10. The system of claim 1, further comprising a telephony authentication system of the telephone, wherein the authentication system sends the first numeric code to the telephony authentication system, wherein the telephony authentication system receives, from the telephone, a second numeric code or a hash of the second numeric code, authenticates the user by comparing the first numeric code to the second numeric code or by comparing a hash of the first numeric code to the hash of the second numeric code, and grants access to the telephone based on the first numeric code matching the second numeric code or the hash of the first numeric code matching the hash of the second numeric code.

11. A method for authenticating a user comprising:
receiving, by a microprocessor, a request to authenticate the user, wherein the request to authenticate the user requires one or more non-numeric metrics to authenticate the user;
validating, by the microprocessor, the request to authenticate the user that requires the one or more non-numeric metrics;
in response to validating the request to authenticate the user that requires the one or more non-numeric metrics, generating, by the microprocessor, a first numeric code, wherein the first numeric code is used to grant access to a telephone that requires authentication via a numeric keypad; and
sending, by the microprocessor, the first numeric code for display to the user.

12. The method of claim 11, further comprising, sending, by the microprocessor, the first numeric code to a telephony authentication system of the telephone, wherein the telephony authentication system authenticates the user at the telephone by comparing the first numeric code to a second numeric code input at the telephone.

13. The method of claim 12, wherein the sent first numeric code is sent based on a request from the telephony authentication system.

14. The method of claim 12, wherein the sent first numeric code is sent based on generating the first numeric code.

15. The method of claim 12, wherein the sent first numeric code is associated with a validity time period.

16. The method of claim 12, wherein telephony authentication system grants access to the telephone if the first numeric code matches the second numeric code.

17. The method of claim 16, wherein the telephony authentication system grants access to an other telephone system based on the access granted to the telephone as part of a single sign-on process.

18. The method of claim 12, wherein comparing the first numeric code to the second numeric code input at the telephone comprises comparing a hash of the first numeric code to a hash of the second numeric code.

19. The method of claim 11, wherein the one or more non-numeric metrics comprise at least one of: a user name, a password, a voiceprint, a facial recognition, a fingerprint, a palm print, a digital certificate, a security card, a user signature, and an iris scan.

20. The method of claim 11, further comprising: sending, by the microprocessor, the first numeric code to a telephony authentication system of the telephone, wherein the telephony authentication system receives, from the telephone, a second numeric code or a hash of the second numeric code, authenticates the user by comparing the first numeric code to the second numeric code or by comparing a hash of the first numeric code to the hash of the second numeric code, and grants access to the telephone based on the first numeric code matching the second numeric code or the hash of the first numeric code matching the hash of the second numeric code.
